(19) United States
(12) Patent Application Publication
(10) Pub. No.: US 2025/0047196 A1
(43) Pub. Date: Feb. 6, 2025

(54) POWER CIRCUIT AND POWER ADAPTER

(71) Applicant: Ace Power and Technology Co.,Ltd, Shanghai (CN)

(72) Inventor: Yuetian WANG, Shanghai (CN)

(73) Assignee: Ace Power and Technology Co.,Ltd, Shanghai (CN)

(21) Appl. No.: 18/923,772

(22) Filed: Oct. 23, 2024

Related U.S. Application Data
(63) Continuation of application No. PCT/CN2023/083093, filed on Mar. 22, 2023.

(30) Foreign Application Priority Data
Apr. 25, 2022 (CN) 202220987159.7

(51) Int. Cl. H02M 1/42; H02M 1/36; H02M 3/335

(52) U.S. Cl. CPC H02M 1/4208; H02M 1/36; H02M 3/33569

(57) ABSTRACT

A power circuit includes a power input terminal, a power factor correction circuit, a DC-DC conversion circuit and a power output terminal connected in sequence. The power factor correction circuit includes an input rectifier unit, a first inductor, a first diode, a first capacitor, a power switch transistor, and a rheostat unit.

### CROSS REFERENCE TO RELATED APPLICATIONS

This application is a Continuation of International Application No. PCT/CN2023/083093, filed on Mar. 22, 2023, which claims the benefit of priority of Chinese Patent Application No. 202220987159.7, filed on Apr. 25, 2022. The disclosures of the above applications are incorporated herein by reference in their entireties.

### TECHNICAL FIELD

The present disclosure relates to power technologies, and more particularly, to a power circuit and a power adapter.

### BACKGROUND

A high-power power adapter generally adopts a topology of a power factor correction (PFC) circuit for a switching direct current (DC) boost topology plus a LLC resonance circuit. For the Boost PFC circuit, the maximum current will be extracted from an on-board alternating current (AC) source in any of the following two conditions: when a power protection point is exceeded; and when the circuit is in a startup process. In each of the two conditions, the maximum current is determined by an overcurrent protection point of the Boost PFC circuit.

On one hand, in order to ensure the full power output of the high-power power adapter, the overcurrent protection point of the Boost PFC circuit should not be set too low. On the other hand, the maximum current during the startup process is limited by the overcurrent protection point of the Boost PFC circuit. In order to ensure that the on-board AC source will not trigger overcurrent protection, the overcurrent protection point of the Boost PFC circuit should not be set too high. Conventionally, the requirement that the overcurrent protection point of the Boost PFC circuit should not be set too low or too high cannot be met.

### SUMMARY

According to one or more embodiments of the present disclosure, a power circuit includes a power input terminal, a power factor correction circuit, a DC-DC conversion circuit and a power output terminal connected in sequence. The power factor correction circuit includes an input rectifier unit, a first inductor, a first diode, a first capacitor, a power switch transistor and a rheostat unit. The input rectifier unit has a first output node and a second output node. The first inductor is connected between the first output node and a positive terminal of the first diode. The first capacitor is connected between a negative terminal of the first diode and the second output node. The power switch transistor and the rheostat unit are connected in series between the positive terminal of the first diode and the second output node. The rheostat unit is configured to change from a first resistance to a second resistance less than the first resistance when the power factor correction circuit has completed startup.

According to one or more embodiments of the present disclosure, a power adapter includes the above power circuit.

### BRIEF DESCRIPTION OF THE DRAWINGS

FIG. 1 is a schematic diagram of an example structure of a power circuit according to one or more embodiments of the present disclosure.

FIG. 2 is a schematic diagram of an example structure of a power circuit according to one or more embodiments of the present disclosure.

FIG. 3 is a schematic diagram of an example structure of a power circuit according to one or more embodiments of the present disclosure.

FIG. 4 is a schematic diagram of an example structure of a power circuit according to one or more embodiments of the present disclosure.

FIG. 5 is a schematic diagram of an example structure of a power circuit according to one or more embodiments of the present disclosure.

FIG. 6 is a schematic diagram of an example structure of a power circuit according to one or more embodiments of the present disclosure.

FIG. 7 is a schematic diagram of an example structure of a power circuit according to one or more embodiments of the present disclosure.

### DETAILED DESCRIPTION

Some embodiments of the present disclosure will be described in detail below with reference to the accompanying drawings. The embodiments are described for illustrative purposes only and are not intended to limit the present disclosure.

In the description of the present disclosure, it is to be understood that the terms “first” and “second” are used for descriptive purposes only and are not to be construed as indicating or implying relative importance or implying the number of indicated technical features. Thus, the features limited by “first” and “second” may explicitly or implicitly include one or more of the features. In the description of the present disclosure, “plurality” means two or more, unless expressly and specifically defined otherwise.

In the present disclosure, the term “exemplary” is used to mean “used as an example, illustration, or illustration.” Any embodiment described as “exemplary” herein is not necessarily to be construed as preferred or advantageous over other embodiments. To enable any person skilled in the art to make and use the present disclosure, the following description is given. In the following description, details are set forth for purposes of explanation. It will be appreciated by those of ordinary skill in the art that the present disclosure may be implemented without these specific details. In other instances, well-known structures and procedures will not be set forth in detail so as not to obscure the description of the present disclosure with unnecessary detail.

As shown in FIG. 1, a power circuit according to one or more embodiments of the present disclosure includes a power input terminal 100, a power factor correction circuit 200, a DC-DC conversion circuit 300, and a power output terminal 400 which are connected in sequence, where the power input terminal 100 includes a neutral wire N and a live wire L.

The power factor correction circuit 200 includes an input rectifier unit 201, a first inductor Lpfc, a first diode Dc, a first capacitor Cm, a power switch transistor S1, and a rheostat unit 202. The first inductor Lpfc and the positive terminal of the first diode Dc connected in series is connected to the first output node of the input rectifier unit 201. Both terminals of the first capacitor Cm are connected to the negative terminal of the first diode Dc and a second output node of the input rectifier unit 201, respectively. The power switch transistor S1 and the rheostat unit 202 are connected in series between the positive terminal of the first diode Dc and the second output node.

When the start of the power factor correction circuit 200 is completed, the resistance value of the rheostat unit 202 is changed from the first resistance value to the second resistance value, and the second resistance value is less than the first resistance value.

In the present disclosure, when the power circuit is in an initial state, that is, when the power factor correction circuit 200 is not started and the DC-DC conversion circuit 300 is not started, the resistance value of the rheostat unit 202 is a first resistance value. When the power factor correction circuit 200 is started, the DC-DC conversion circuit 300 is not started, and the power switch transistor S1 is turned on, a power signal passes through the first inductor Lpfc, and the current in the first inductor Lpfc rises. At this time, since the resistance value of the rheostat unit 202 is kept at the first resistance value, the overcurrent protection point is low, so that a relatively small starting current is ensured, thereby preventing from triggering overcurrent protection of the power circuit. When the start of the power factor correction circuit 200 is completed, that is, when the start of the power factor correction circuit 200 is completed and the condition for starting the DC-DC conversion circuit 300 is reached, the resistance value of the rheostat unit is converted to the second resistance value, where the second resistance value is less than the first resistance value. At this time, the overcurrent protection point becomes relatively high, so that it is ensured that the power circuit can output at full load when connected to an external power, thereby solving a problem that the overcurrent protection point is too low to implement the full power output of the power circuit.

In a possible embodiment, the input rectifier unit 201 is connected to the power input terminal 100 for rectifying the power input signal. Specifically, the input rectifier unit 201 includes a full-wave rectifier bridge including diodes D1˜D4. The connection point between the negative terminal of the diode D1 and the negative terminal of the diode D2 forms the first output node of the input rectifier unit, and the connection point between the positive terminal of the diode D3 and the positive terminal of the diode D4 forms the second output node of the input rectifier unit. After the power signal is input to the input rectifier unit 201 through the power input terminal 100, the first output node and the second output node output the rectified power signal. The input rectifier unit 201 may also be another rectifier circuit, which is merely illustrated here and is not unduly limited thereto.

After one terminal of the first inductor Lpfc is connected to the first output node of the input rectifier unit 201, and the other terminal of the first inductor Lpfc is connected in series with the positive terminal of the first diode Dc, both terminals of the first capacitor Cm are connected to the negative terminal of the first diode Dc and the second output node of the input rectifier unit 201, respectively. In the present embodiment, the first inductor Lpfc is an energy storage inductor, and the first capacitor Cm is a filter capacitor. When the power switch transistor S1 is turned on, the rectified power signal passes through the first inductor Lpfc, and the current in the first inductor Lpfc rises. When the power switch transistor S1 is turned off, the current stored in the first inductor Lpfc charges the first capacitor Cm through the first diode Dc. When the voltage across the first capacitor Cm reaches a predetermined value, the DC-DC conversion circuit 300 is driven to start.

In a possible embodiment, in the power factor correction circuit 200, the position relationship between the rheostat unit 202 and the power switch transistor S1 may be that the rheostat unit 202 is connected to the second output node of the input rectifier unit 201, and the power switch transistor S1 is connected between the rheostat unit 202 and the positive terminal of the first diode Dc, and also may be that the first terminal of the power switch transistor S1 is connected to the second output node of the input rectifier unit 201, and the rheostat unit 202 is connected between the second terminal of the power switch transistor S1 and the positive terminal of the first diode Dc. The arrangement positions of the rheostat unit and the power switch transistor in the power factor correction circuit are not specifically limited herein.

In a possible embodiment, for ease of understanding, the positional relationship between the rheostat unit 202 and the power switch transistor S1 may be as shown in FIG. 1. Specifically, the rheostat unit 202 further includes a first switch transistor Q1, a first resistor Rv, and a switch enable control part 500. The first terminal and the second terminal of the first switch transistor Q1 are connected to both terminals of the first resistor Rv, respectively. The switch enable control part 500 is connected to the control terminal of the first switch transistor Q1, the power factor correction circuit 200, and/or the DC-DC conversion circuit 300. The switch enable control part 500 is used for controlling the first switch transistor Q1 to be turned on or off.

In an application, when the power factor correction circuit 200 is started and the DC-DC conversion circuit 300 is not started, the power switch transistor S1 is turned on. In this case, the first switch transistor Q1 is in an off state which is initially set. The current overcurrent protection point of the power factor correction circuit 200 is determined by a first resistance value, that is, the resistance value of the sampling resistance Rv. Since the resistance value of the sampling resistance Rv is large, the overcurrent protection point is low, and the current in the power circuit is small, that is, the current flowing through the power switch transistor S1 is small, thereby ensuring a relatively small start current. When the voltage value of the first voltage reaches the set voltage value for starting the DC-DC conversion circuit 300, the switch enable control part 500 controls the first switch transistor Q1 to be turned on. In this case, the current overcurrent protection point of the power factor correction circuit 200 is determined by the second resistance value, which is the parallel value of the sampling resistance Rv and the turn-on resistance value of the first switch transistor Q1. Since the parallel value of the sampling resistance Rv and the turn-on resistance value of the first switch transistor Q1 is less than the resistance value of only the sampling resistor Rv, the over-current protection point becomes high, so that a large current can flow through the power circuit, that is, a large current can flow through the power switch transistor S1, thereby ensuring that the power circuit can output at full load when connected to an external power.

In a possible embodiment, the DC-DC conversion circuit 300 comprises a first bridge arm, a resonance capacitor Cr, a resonance inductor Lr, and a transformer Tr. The first bridge arm is connected across both terminals of the first capacitor Cm. The first bridge arm includes a half bridge arm including a second switch transistor Q2 and a third switch transistor Q3 connected in series. The coupling point between the second switch transistor Q2 and the third switch transistor Q3 is the output midpoint Y1. Specifically, the source of the second switch transistor Q2 is connected to one terminal of the first capacitor Cm, the drain of the second switch transistor Q2 is connected to the source of the first switch transistor Q1, and the drain of the second switch transistor Q2 is connected to the other terminal of the first capacitor Cm.

One terminal of the resonance capacitor Cr is connected to the output midpoint Y1 of the first bridge arm, the other terminal of the resonance capacitor Cr is connected to the resonance inductor Lr. The other terminal of the resonance inductor Lr is connected to the first terminal of the primary winding of the transformer Tr, and the second terminal of the primary winding of the transformer Tr is connected to one of the coupling points of the first bridge arm and the filter capacitor Cm. The secondary winding of the transformer Tr is connected to the power output terminal.

In a possible embodiment, the DC-DC conversion circuit further includes an output rectifier unit connected between the secondary winding of the transformer and the power output terminal for rectifying the power signal output by the transformer. The output rectifier unit include a rectifier circuit including a fourth switch transistor Q4 and a fifth switch transistor Q5.

In an application, when the voltage across the first capacitor Cm reaches a preset voltage value, by controlling the second switch transistor Q2 and the third switch transistor Q3 to be alternately turned on and off, the voltage at the output midpoint Y1 is a square wave voltage whose waveform is a square wave from 0V to the preset voltage value. At this time, the resonance capacitor Cr and the resonance inductor Lr work together to form a resonance cavity, which is connected to the transformer Tr, and rectified by the output rectifier unit to provide an output power signal to the power output terminal 400. For example, when the voltage across the first capacitor Cm reaches 400V, the second switch transistor Q2 and the third switch transistor Q3 are alternately turned on and off, so that a square wave voltage of 0 V to 400V is outputted at the output midpoint Y1, and the transformer Tr is driven to output a voltage to the power output terminal 400. In one or more embodiments, the preset voltage value is not specifically limited, and may be adjusted according to actual situations.

In the present disclosure, each of the power switch transistor S1, the first switch transistor Q1, the second switch transistor Q2, and the third switch transistor Q3 may be a triode, a Metal-Oxide-Semiconductor Field-Effect Transistor (MOSFET), a thyristor, or other device capable of realizing a switch function, which is not specifically limited herein and may be adjusted based on actual situations.

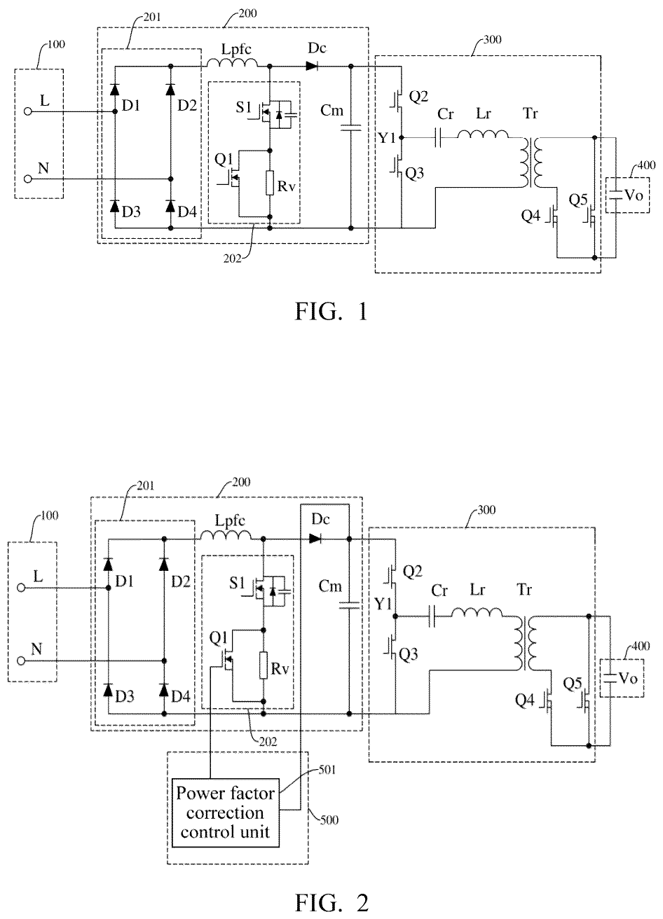

As shown in FIG. 2, the switch enable control part 500 includes a power factor correction control unit 501 for outputting a control signal for driving the first switch transistor Q1 to be turned on based on whether the first voltage value of the first voltage outputted by the power factor correction circuit 200 reaches the set voltage value for starting the DC-DC conversion circuit 300.

In the present embodiment, the first voltage value of the power signal outputted by the power factor correction circuit 200 may be a bus voltage across the bus capacitor Cm. As shown in FIG. 2, the voltage across the first capacitor Cm is detected by the power factor correction control unit 501, that is, the first voltage value of the first voltage is obtained.

In the actual application, the power circuit is provided with the power factor correction control unit 501 for controlling the operation of the power factor correction circuit 200. Therefore, in the present embodiment, the first voltage value of the power signal outputted by the power factor correction circuit 200 is detected directly by the power factor correction control unit 501. When the first voltage value meets the preset voltage value, the power factor correction control unit 501 outputs a control signal for driving the first switch transistor Q1 to be turned on, thereby implementing full power output of the power circuit.

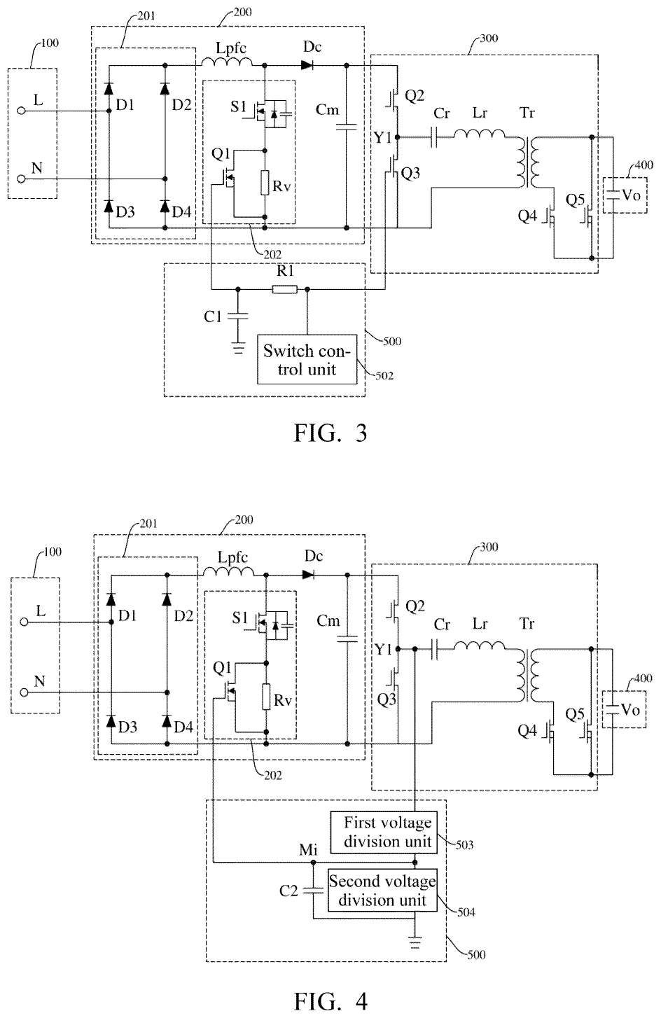

In another embodiment of the present disclosure, as shown in FIG. 3, the switch enable control part 500 includes a first switch control unit 502, a second resistor R1, and a second capacitor C1. The first switch control unit 502 includes a signal output terminal connected to the control terminal of the DC-DC conversion circuit and one terminal of the second resistor R1. Specifically, the DC-DC conversion circuit includes a third switch transistor Q3, and the control terminal of the DC-DC conversion circuit includes the control terminal of the third switch transistor Q3. That is, the signal output terminal is connected to the control terminal of the third switch transistor Q3 and one terminal of the second resistor R1. The other terminal of the second resistor R1 is connected to the control terminal of the first switch transistor Q1 and the second capacitor C1, and the other terminal of the second capacitor C1 is grounded.

In the present embodiment, when the first voltage outputted by the power factor correction circuit satisfies the preset voltage value, it is necessary to control the second switch transistor Q2 and the third switch transistor Q3 to be alternately turned on and turned off to drive the DC-DC conversion circuit to start. Therefore, when the switch control unit 502 outputs a drive signal to drive the third switch transistor Q3 to operate, the first switch transistor Q1 is also driven by the drive signal to operate, thereby implementing the full power output of the power circuit.

In another embodiment of the present disclosure, as shown in FIG. 4, the switch enable control part 500 includes a first voltage divider 503, a second voltage divider 504, and a third capacitor C2. The first voltage divider 503 and the second voltage divider 504 connected in series is connected to the output midpoint Y1. The connection point between the first voltage divider 503 and the second voltage divider 504 forms a control node Mi. One terminal of the third capacitor C2 is connected to the control node Mi, and the other terminal of the third capacitor C2 is grounded. The control node Mi is connected to the control terminal of the first switch transistor Q1.

In the present embodiment, after the bus voltage output by the power factor correction circuit satisfies the preset voltage value, the square wave voltage at the output midpoint Y1 is divided by the first voltage divider 503 and the second voltage divider 504, and the third capacitor C2 is charged by the divided voltage signal, so that the voltage value satisfying the turn-on condition of the first switch transistor Q1 is formed at the control node Mi, and the first switch transistor Q1 is driven to be turned on, thereby implementing full power output of the power circuit.

In the present embodiment, the circuit including the first voltage divider 503 and the second voltage divider 504 may be a circuit including two resistors, a circuit including two diodes, or a circuit including a combination of the two types of components. For ease of understanding, the circuits adopted by the first voltage divider 503 and the second voltage divider 504 will be described in detail below.

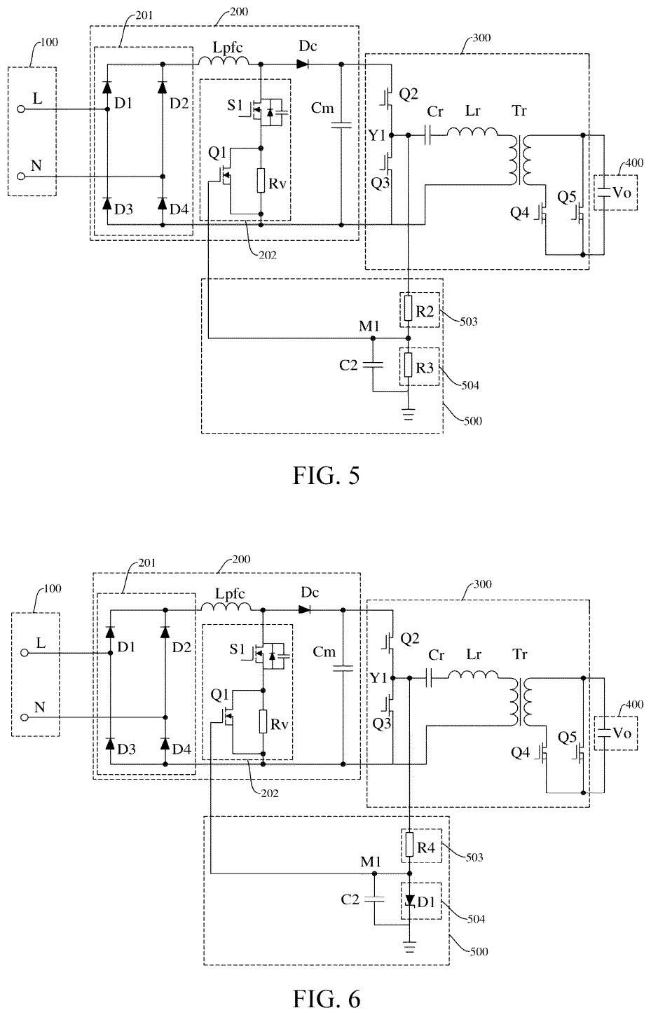

In another embodiment of the present disclosure, as shown in FIG. 5, the first voltage divider 503 includes a third resistor R2, and the second voltage divider 504 includes a fourth resistor R3. The control node Mi includes a first node M1, and the third resistor R2 and the fourth resistor R3 are connected in series and form the first node M1 at the connection point. The other terminal of the third resistor R2 is connected to the output midpoint Y1, and the other terminal of the fourth resistor R3 is grounded. One terminal of the third capacitor C2 is connected to the first node M1. The other terminal of the third capacitor C2 is grounded. The first node M1 is connected to the control terminal of the first switch transistor Q1.

In the present embodiment, after the bus voltage outputted by the power factor correction circuit meets the preset voltage value, it is divided by the third resistor R2 and the fourth resistor R3, and the third capacitor C2 is charged by the divided voltage signal, so that the voltage value satisfying the turn-on condition of the first switch transistor Q1 is formed at the first node M1, and the first switch transistor Q1 is driven to be turned on, thereby implementing full power output of the power circuit.

In another embodiment of the present disclosure, as shown in FIG. 6, the first voltage divider 503 includes a fifth resistor R4, and the second voltage divider 504 includes a second diode D1. The control node Mi includes a second node M2. The fifth resistor R4 and the positive terminal of the second diode D1 connected in series is connected between the output midpoint Y1 and the ground point. The connection point between the fifth resistor R4 and the positive terminal of the second diode D1 forms the second node M2. One terminal of the third capacitor C2 is connected to the second node M2, and the other terminal of the third capacitor C2 is grounded. The second node M2 is connected to the control terminal of the first switch transistor Q1. The second diode D1 is a voltage stabilizing diode.

The position relationship between the fifth resistor R4 and the second diode D1 may be that one terminal of the fifth resistor R4 is connected to the output midpoint Y1, and the other terminal of the fifth resistor R4 is connected to the positive terminal of the second diode D1, and also may be that the positive terminal of the second diode D1 is connected to the output midpoint Y1, and the negative terminal of the second diode D1 is connected to the fifth resistor R4. The arrangement positions of the rheostat unit and the power switch transistor in the power factor correction circuit is not specifically limited herein. For ease of understanding, the scheme shown in FIG. 6 is adopted in this embodiment, that is, the other terminal of the fifth resistor R4 is connected to the output midpoint Y1, the negative terminal of the second diode D1 is grounded, and one terminal of the fifth resistor R4 and the positive terminal of the second diode D1 are connected in series and forms the second node M2 at the connection point.

In this embodiment, after the bus voltage outputted by the power factor correction circuit meets the preset voltage value, it is divided by the fifth resistor R4 and the second diode D1, and the third capacitor C2 is charged by the divided voltage signal, so that the voltage value satisfying the turn-on condition of the first switch transistor Q1 is formed at the second node M2, and the first switch transistor Q1 is driven to be turned on, thereby implementing full power output of the power circuit.

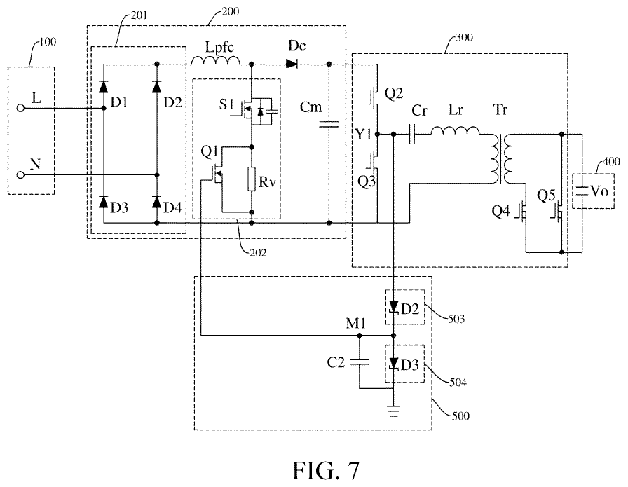

In another embodiment of the present disclosure, as shown in FIG. 7, the first voltage divider 503 includes a third diode D2, and the first voltage divider 503 includes a fourth diode D3. The control node Mi includes a third node M3. The negative terminal of the third diode D2 and the positive terminal of the fourth diode D3 are connected in series and forms the third node M3 at the connection point. The positive terminal of the third diode D2 is connected to the output midpoint Y1. The negative terminal of the fourth diode D3 is grounded. One terminal of the third capacitor C2 is connected to the third node M3, and the other terminal of the third capacitor C2 is grounded. The third node M3 is connected to the control terminal of the first switch transistor Q1. The third diode D2 and the fourth diode D3 are voltage stabilizing diodes.

In the present embodiment, after the bus voltage outputted by the power factor correction circuit meets the preset voltage value, it is by the third diode D2 and the fourth diode D3, and the third capacitor C2 is charged by the divided voltage signal, so that a voltage value satisfying the turn-on condition of the first switch transistor Q1 is formed at the third node M3, and the first switch transistor Q1 is driven to be turned on, thereby implementing full power output of the power circuit.

In one or more embodiments of the present disclosure, a power adapter includes the power circuit described above.

Some embodiments of the present disclosure have been described in detail above. The description of the embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure.

What is claimed is:

1. A power circuit, comprising a power input terminal, a power factor correction circuit, a DC-DC conversion circuit and a power output terminal connected in sequence,
wherein the power factor correction circuit comprises an input rectifier unit, a first inductor, a first diode, a first capacitor, a power switch transistor and a rheostat unit;
the input rectifier unit has a first output node and a second output node;
the first inductor is connected between the first output node and a positive terminal of the first diode;
the first capacitor is connected between a negative terminal of the first diode and the second output node;
the power switch transistor and the rheostat unit are connected in series between the positive terminal of the first diode and the second output node; and
the rheostat unit is configured to change from a first resistance to a second resistance less than the first resistance when the power factor correction circuit has completed startup.

2. The power circuit according to claim 1, wherein the rheostat unit comprises a first switch transistor, a first resistor, and a switch enable control part;
the first switch transistor has a first terminal and a second terminal respectively connected to both terminals of the first resistor; and
the switch enable control part is connected to at least one of a control terminal of the first switch transistor, the power factor correction circuit or the DC-DC conversion circuit, and configured to control the first switch transistor to be turned on/off.

3. The power circuit according to claim 2, wherein the DC-DC conversion circuit comprises a first bridge arm, a resonance capacitor, a resonance inductor and a transformer;
the first bridge arm is connected with the first capacitor in parallel through two nodes;
the resonance capacitor is connected between an output midpoint of the first bridge arm and a first terminal of the resonance inductor; and
a primary winding of the transformer has a first terminal connected to a second terminal of the resonance inductor and a second terminal connected to one of the two nodes, and a secondary winding of the transformer is connected to the power output terminal.

4. The power circuit according to claim 3, wherein the switch enable control part comprises a power factor correction control unit for outputting a control signal to control the first switch transistor to be turned on based on a first voltage output from the power factor correction circuit.

5. The power circuit according to claim 3, wherein the switch enable control part comprises a first switch control unit, a second resistor and a second capacitor;
the first switch control unit has a signal output terminal connected to a control terminal of the DC-DC conversion circuit and a first terminal of the second resistor;
a second terminal of the second resistor is connected to the control terminal of the first switch transistor and a first terminal of the second capacitor; and
a second terminal of the second capacitor is grounded.

6. The power circuit according to claim 3, wherein the switch enable control part comprises a first voltage divider, a second voltage divider, and a third capacitor;
the first voltage divider is connected with the second voltage divider in series through a control node which is connected to the control terminal of the first switch transistor;
the first voltage divider is connected between the control node and the output midpoint; and
the third capacitor is connected with the second voltage divider in parallel, and has a first terminal connected to the control node and a second terminal grounded.

7. The power circuit according to claim 6, wherein the first voltage divider comprises a third resistor, and the second voltage divider comprises a fourth resistor.

8. The power circuit according to claim 6, wherein the first voltage divider comprises a fifth resistor, and the second voltage divider comprises a second diode; and
the second diode has a positive terminal connected to the control node and a negative terminal grounded.

9. The power circuit according to claim 6, wherein the first voltage divider comprises a third diode, and the second voltage divider comprises a fourth diode;
the third diode has a positive terminal connected to the output midpoint and a negative terminal connected to the control node; and
the fourth diode has a positive terminal connected to the control node and a negative terminal grounded.

10. A power adapter, comprising the power circuit, the power circuit comprising a power input terminal, a power factor correction circuit, a DC-DC conversion circuit and a power output terminal connected in sequence,
wherein the power factor correction circuit comprises an input rectifier unit, a first inductor, a first diode, a first capacitor, a power switch transistor and a rheostat unit;
the input rectifier unit has a first output node and a second output node;
the first inductor is connected between the first output node and a positive terminal of the first diode;
the first capacitor is connected between a negative terminal of the first diode and the second output node;
the power switch transistor and the rheostat unit are connected in series between the positive terminal of the first diode and the second output node; and
the rheostat unit is configured to change from a first resistance to a second resistance less than the first resistance when the power factor correction circuit has completed startup.

11. The power adapter according to claim 10, wherein the rheostat unit comprises a first switch transistor, a first resistor, and a switch enable control part;
the first switch transistor has a first terminal and a second terminal respectively connected to both terminals of the first resistor; and
the switch enable control part is connected to at least one of a control terminal of the first switch transistor, the power factor correction circuit or the DC-DC conversion circuit, and configured to control the first switch transistor to be turned on/off.

12. The power adapter according to claim 11, wherein the DC-DC conversion circuit comprises a first bridge arm, a resonance capacitor, a resonance inductor and a transformer;
the first bridge arm is connected with the first capacitor in parallel through two nodes;
the resonance capacitor is connected between an output midpoint of the first bridge arm and a first terminal of the resonance inductor; and
a primary winding of the transformer has a first terminal connected to a second terminal of the resonance inductor and a second terminal connected to one of the two nodes, and a secondary winding of the transformer is connected to the power output terminal.

13. The power adapter according to claim 12, wherein the switch enable control part comprises a power factor correction control unit for outputting a control signal to control the first switch transistor to be turned on based on a first voltage output from the power factor correction circuit.

14. The power adapter according to claim 12, wherein the switch enable control part comprises a first switch control unit, a second resistor and a second capacitor;
the first switch control unit has a signal output terminal connected to a control terminal of the DC-DC conversion circuit and a first terminal of the second resistor;
a second terminal of the second resistor is connected to the control terminal of the first switch transistor and a first terminal of the second capacitor; and
a second terminal of the second capacitor is grounded.

15. The power adapter according to claim 12, wherein the switch enable control part comprises a first voltage divider, a second voltage divider, and a third capacitor;
the first voltage divider is connected with the second voltage divider in series through a control node which is connected to the control terminal of the first switch transistor;
the first voltage divider is connected between the control node and the output midpoint; and
the third capacitor is connected with the second voltage divider in parallel, and has a first terminal connected to the control node and a second terminal grounded.

16. The power adapter according to claim 15, wherein the first voltage divider comprises a third resistor, and the second voltage divider comprises a fourth resistor.

17. The power adapter according to claim 15, wherein the first voltage divider comprises a fifth resistor, and the second voltage divider comprises a second diode; and
the second diode has a positive terminal connected to the control node and a negative terminal grounded.

18. The power adapter according to claim 15, wherein the first voltage divider comprises a third diode, and the second voltage divider comprises a fourth diode;
the third diode has a positive terminal connected to the output midpoint and a negative terminal connected to the control node; and
the fourth diode has a positive terminal connected to the control node and a negative terminal grounded.
